(19) United States
(12) Patent Application Publication
(10) Pub. No.: US 2007/0118269 A1
(43) Pub. Date: May 24, 2007

(54) Engine control unit to valve control unit interface

(76) Inventors: Alex Gibson, Ann Arbor, MI (US); Joseph L. Thomas, Kimball, MI (US); Yan Wang, Ann Arbor, MI (US); Brian C. Moorhead, Willis, MI (US); Vince Winstead, Farmington Hills, MI (US)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/282,131

(22) Filed: Nov. 18, 2005

(51) Int. Cl. B60T 7/12

(52) U.S. Cl. 701/84; 701/101

(57) ABSTRACT

A method for controlling engine torque during disruption of a primary communication link between an engine control unit and a valve control unit in an engine is provided. The method includes determining disruption of the primary communication link between the engine control unit and the valve control unit, operating a preset valve timing schedule upon determination of disruption of the communication link between the engine control unit and the valve control unit; and sending a status message from the valve control unit to the engine control unit regarding the operational status of the valve control unit.

### FIELD

The present application relates to a system and method for controlling engine torque.

### BACKGROUND AND SUMMARY

Operation of an engine may be improved by accurately delivering a desired engine torque, such as via valve operation and/or throttle control. For example, varying the valve timing may result in rapid and accurate control of the engine torque.

In some cases, valve timing may be managed by a valve control unit (VCU). An engine control unit (ECU) may relay to the valve control unit desired/actual valve timing information. In one example, the engine control unit is linked to the valve control unit through a communication link which enables the engine control unit to provide commands to control operation of the valve control unit. The control of operation of the valve control unit enables selective management of the valve timing which may enhance operation of the engine. The engine control unit and valve control unit may be coupled through a dedicated controller area network (CAN) which enables one-on-one communication between the engine control unit and the valve control unit.

However, the inventors herein have recognized the need for a back up or limited operating state system for operation and control of the valves. For example, the dedicated link between the engine control unit and the valve control unit may degrade or may provide intermittent communication. During such a situation, no new control information may be sent to the valves, and operation of the valves may be interrupted. Restoration of operational control of the valve timing may be difficult.

In one approach, at least some of the above disadvantages may be overcome by a method providing for backing up the dedicated communication link between the engine control unit and the valve control unit. The method comprises providing a back up system and a message system. As such, upon determination of degradation of the dedicated communication link between the engine control unit and the valve control unit, a preloaded valve timing schedule is introduced by the valve control unit. Further, a message system is activated to transmit operational status information to the engine control unit from the valve control unit. In this way, it is possible to provide continual valve control while enabling restoration of the communication link between the engine control unit and the valve control unit.

In one approach, at least some of the above disadvantages may be overcome by a method for controlling engine operation, comprising: stopping engine operation in response to degraded communication between an engine control unit and a valve control unit, where the valve control unit controls valve operation of at least one electrically actuated cylinder valve of the engine, and restarting the engine, even in the presence of the degraded communication, using a communication of cam or crank angle separate from said degraded communication. In this way, it is possible to restart an engine in the event of an engine stall or purposeful shutdown in the event of degraded communication. This may be especially advantageous on an engine having both electrically and cam actuated valves, as synchronization may be useful to provide proper valve timing for the combustion cycles.

### BRIEF DESCRIPTION OF THE DRAWINGS

FIG. 1 is a schematic diagram of an engine;

FIG. 2 is a schematic diagram of an engine valve;

FIG. 3 is a schematic illustration of modes of controlling engine torque;

FIG. 4 is a flowchart of an example method of controlling engine torque;

FIG. 5 is a schematic diagram of an example interface between the engine control unit and the valve control unit;

FIG. 6 is a schematic diagram of another example interface between the engine control unit and the valve control unit;

FIG. 7 is a chart of example messages for messaging system between the valve control unit and the engine control unit;

FIG. 8 is a schematic diagram of another example illustrating signal filtering that may be used.

### DETAILED DESCRIPTION

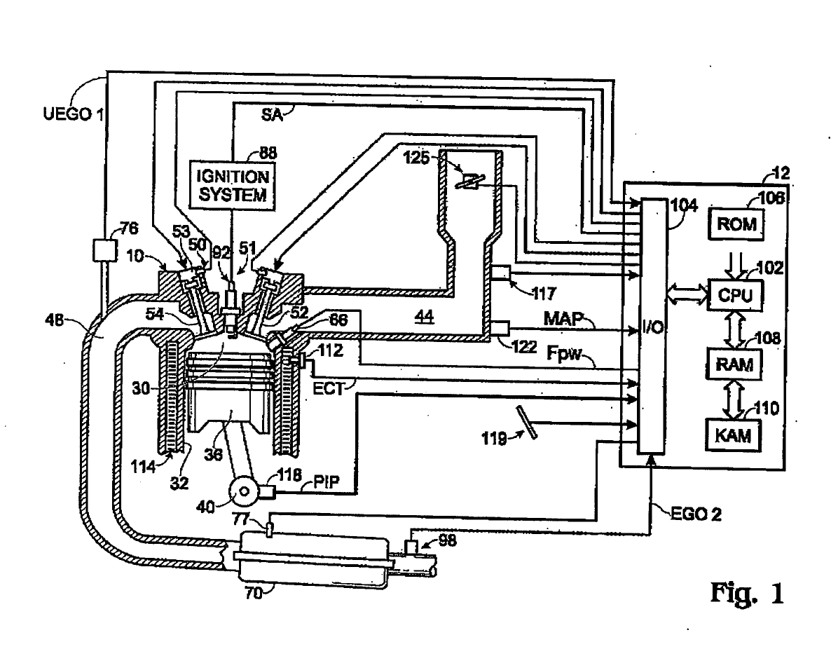

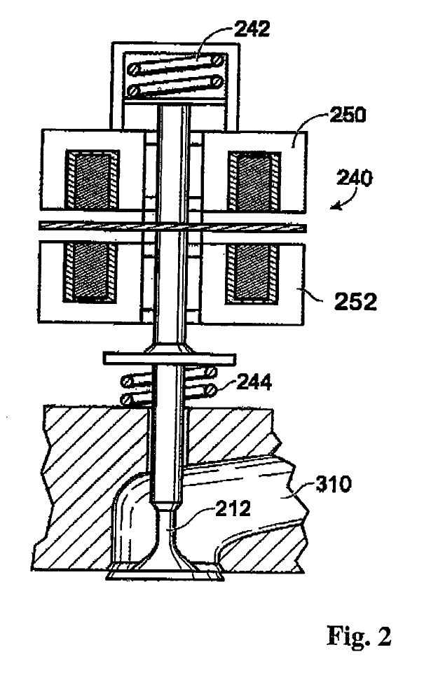

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 an exhaust valve 54. Each intake and exhaust valve is operated by an electromechanically controlled valve coil and armature assembly 53, such as shown in FIG. 2. Armature temperature is determined by temperature sensor 51. Valve position is determined by position sensor 50. In an alternative example, each of valves actuators for valves 52 and 54 has a position sensor and a temperature sensor. In still another alternative, one or more of intake valve 52 and/or exhaust valve 54 may be cam actuated, and be capable of mechanical deactivation. For example, lifters may include deactivation mechanism for push-rod type cam actuated valves. Alternatively, deactivators in an overhead cam may be used, such as by switching to a zero-lift cam profile.

Intake manifold 44 is also shown having fuel injector 66 coupled thereto for delivering liquid fuel in proportion to the pulse width of signal FPW from controller 12. Fuel is delivered to fuel injector 66 by fuel system (not shown) including a fuel tank, fuel pump, and fuel rail. Alternatively, the engine may be configures such that the fuel is injected directly into the engine cylinder, which is known to those skilled in the art as direct injection. In addition, intake manifold 44 is shown communicating with optional electronic throttle 125.

Distributorless ignition system 88 provides ignition spark to combustion chamber 30 via spark plug 92 in response to controller 12. Universal Exhaust Gas Oxygen (UEGO) sensor 76 is shown coupled to exhaust manifold 48 upstream of catalytic converter 70. Alternatively, a two-state exhaust gas oxygen sensor may be substituted for UEGO sensor 76. Two-state exhaust gas oxygen sensor 98 is shown coupled to exhaust manifold 48 downstream of catalytic converter 70. Alternatively, sensor 98 can also be a UEGO sensor. Catalytic converter temperature is measured by temperature sensor 77, and/or estimated based on operating conditions such as engine speed, load, air temperature, engine temperature, and/or airflow, or combinations thereof.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, and read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 119 coupled to a accelerator pedal; a measurement of engine manifold pressure (MAP) from pressure sensor 122 coupled to intake manifold 44; a measurement (ACT) of engine air amount temperature or manifold temperature from temperature sensor 117; and a engine position sensor from a Hall effect sensor 118 sensing crankshaft 40 position. In a preferred aspect of the present description, engine position sensor 118 produces a predetermined number of equally spaced pulses every revolution of the crankshaft from which engine speed (RPM) can be determined. The output of sensor 118 can be used to identify engine position.

In one example where cam actuated valves are used (along or in addition to electrically actuated valves), a camshaft sensor may also be used. In such cases, a combination of information from the camshaft sensor and crankshaft sensor can be used to identify engine position. For example, these sensors can be coupled with toothed wheels. In one particular embodiment, the crank shaft can have a decoder wheel with one or two missing teeth. The missing teeth may be used to decode top dead center position (TDC). The crankshaft signal may be referred to as a CPS signal. The camshaft can also have a decoder that puts out one pulse per cam shaft revolution (720 crank angle degrees) to identify stroke, or be a toothed wheel with one or more missing teeth. The crankshaft signal may be referred to as a CAM signal, with a missing tooth referring to a CID signal, for example.

In an alternative embodiment, a direct injection type engine can be used where injector 66 is positioned in combustion chamber 30, either in the cylinder head similar to spark plug 92, or on the side of the combustion chamber. Also, the engine may be coupled to an electric motor/battery system in a hybrid vehicle. The hybrid vehicle may have a parallel configuration, series configuration, or variation or combinations thereof.

FIG. 2 shows an example dual coil oscillating mass actuator 240 with an engine valve actuated by a pair of opposing electromagnets (solenoids) 250, 252, which are designed to overcome the force of a pair of opposing valve springs 242 and 244. FIG. 2 also shows port 310, which can be an intake or exhaust port. Applying a variable voltage to the electromagnet's coil induces current to flow, which controls the force produced by each electromagnet. Due to the design illustrated, each electromagnet that makes up an actuator can only produce force in one direction, independent of the polarity of the current in its coil. High performance control and efficient generation of the required variable voltage can therefore be achieved by using a switch-mode power electronic converter. Alternatively, electromagnets with permanent magnets may be used that be attracted or repelled.

As illustrated above, the electromechanically actuated valves in the engine remain in the half open position when the actuators are de-energized. Therefore, prior to engine combustion operation, each valve goes through an initialization cycle. During the initialization period, the actuators are pulsed with current, in a prescribed manner, in order to establish the valves in the fully closed or fully open position. Following this initialization, the valves are sequentially actuated according to the desired valve timing (and firing order) by the pair of electromagnets, one for pulling the valve open (lower) and the other for pulling the valve closed (upper).

The magnetic properties of each electromagnet are such that only a single electromagnet (upper or lower) need be energized at any time. Since the upper electromagnets hold the valves closed for the majority of each engine cycle, they are operated for a much higher percentage of time than that of the lower electromagnets.

While FIG. 2 shows the valves to be permanently attached to the actuators, in practice there can be a gap to accommodate lash and valve thermal expansion.

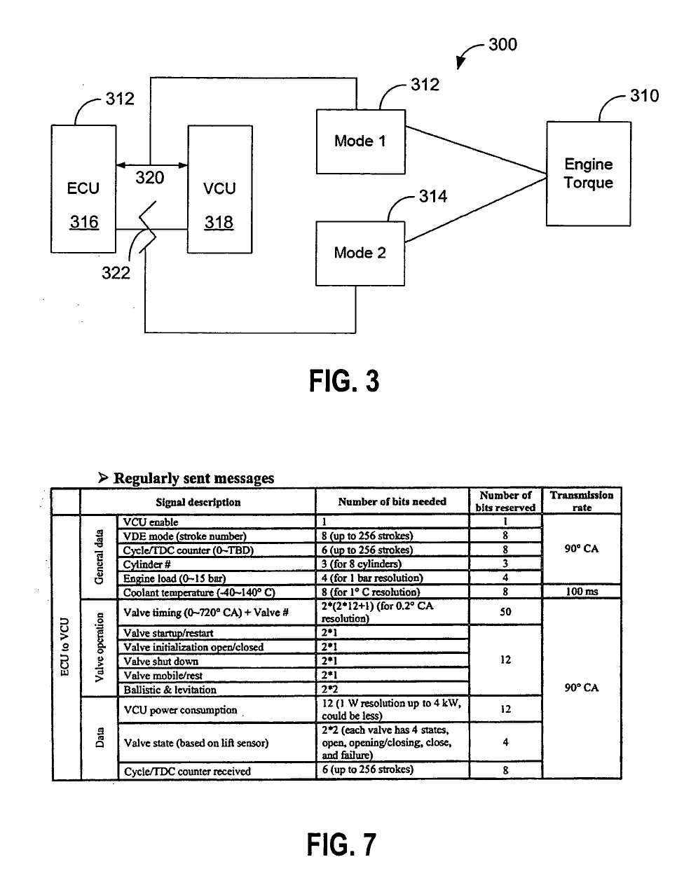

Referring now to FIG. 3, a schematic illustration of a method of enhancing engine operation by controlling engine torque is provided generally at 300. As shown, engine torque 310 may be controlled through at least a first mode, Mode 1, indicated at 312 and a second mode, Mode 2, indicated at 314.

In Mode 1, the engine control unit 316 is in communication with the valve control unit 318. This communication link or interface is operational (indicated at 320), such that the valve control unit uses engine control unit commands to deliver a desired engine torque. Thus, valve timing and throttle can be used to deliver desired torque by varying valve timing to control torque. Mode 1 may be considered ECU-commanded valve timing.

In Mode 2, the interface or communication link between the engine control unit 316 and valve control unit 318 maybe disrupted or degraded as indicated at 322. Mode 2 provides the operation of the engine in torque control mode after a degradation or disruption in the engine control unit to valve control unit primary communication link. A fixed or preloaded valve timing schedule may be used during the communication disruption. For example, the throttle may be used to deliver a desired torque with a fixed or preset valve timing schedule. The preset valve timing schedule may be included with the valve control unit. No communication may be needed with the engine control unit for operation of the preset valve timing schedule. The schedule may vary as a function of engine speed.

In some embodiments, a transition strategy may be provided for the transition from the ECU-commanded valve timing schedule, e.g. the transition immediately after communication degradation between the ECU and the VCU is detected, to the preset valve timing schedule to minimize torque transients during the initial transition phase. Further, a second transition or restoration strategy may be used for transition from the preset valve timing schedule to the ECU-commanded valve timing schedule.

As discussed in more detail below, additional signal communication or back up signal system may be provided between the engine control unit and the valve control unit. For example, a separate signal line or back up communication BUS may be used to transmit CID or CAM signals from the engine control unit to the valve control unit. For example, the backup signal system may allow engine re-starting in the event of a stall after a temporary or permanent degradation in the engine control unit to valve control unit primary communication link. Moreover, it may be possible to recover from a loss of the CPS signal with a low fidelity, e.g. once per 90 degree signal. In other words, if degraded communication between a valve controller and an engine control unit results in a need for an engine restart, the engine may be restarted even if the degraded communication exists since a cam or crank signal is still provided to the engine control unit via a separate communication.

As discussed in more detail below, a message system may be provided to enable communication between the valve control unit and the engine control unit. For example, a separate signal line or back up communication BUS may be used to transmit VCU status messages. The status messages from the valve control unit to the engine control unit may allow the transmission of operation states to the engine control unit. For example, the valve control unit may be configured to transmit status messages regarding loss of power to the valve control unit; primary communication link status; or other operational status information. Operation status information may include messages regarding identifying or communicating that suitable conditions exist to run or restart engine with all cylinders or that suitable conditions exist to run or restart with reduced number of cylinders. In some embodiments, the message may include information regarding the cylinder or valve number identifier to identify degraded cylinders/valves and/or commands to the engine control unit to shut off fuel/spark to one or more degraded cylinders. Additionally, the message system may provide for a RPM signal verification. For example, the message may provide information regarding use of CPS to calculate engine speed, use of CAM signal to calculate engine speed, and/or low bit RPM value, e.g. 6 to 8 RPM signal.

In one example, the VCU Status signal can be a digital pulse train that is based upon a given message structure, e.g. Manchester encoding, or it can be as a PWM signal that is used to reflect the VCU calculation of the engine speed back to the engine control module. Specifically, in one particular embodiment, the VCU calculation of the engine speed can be transmitted as the VCU Status signal using a twisted pair that is driven by a PWM driver on the VCU.

As will be appreciated by one of ordinary skill in the art, the specific routines described below in the flowcharts may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the disclosure, but is provided for ease of illustration and description. Although not explicitly illustrated, one of ordinary skill in the art will recognize that one or more of the illustrated steps or functions may be repeatedly performed depending on the particular strategy being used. Further, these Figures graphically represent code to be programmed into the computer readable storage medium in controller 12.

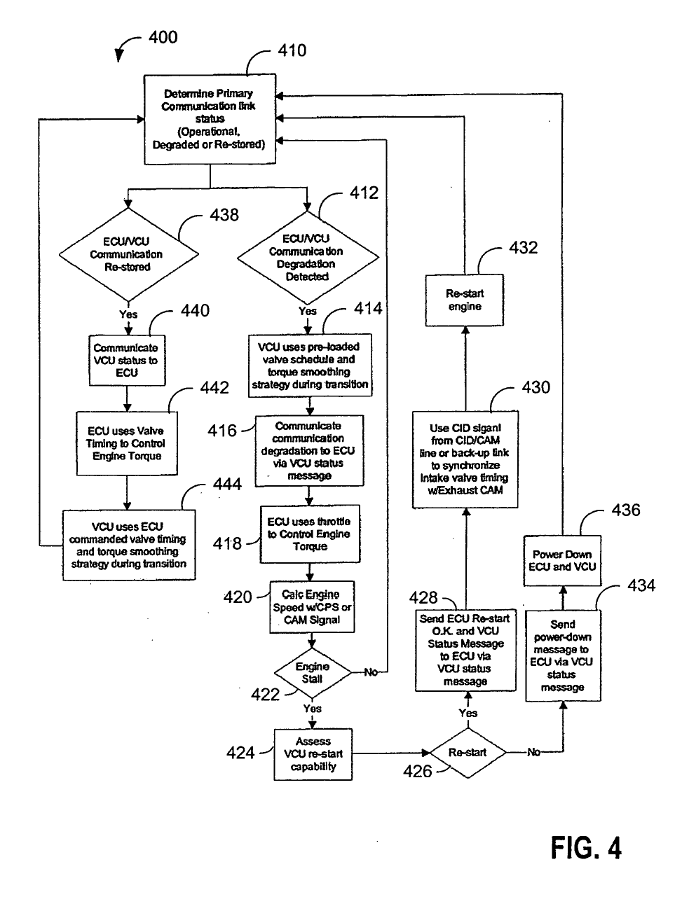

Referring now to FIG. 4, an exemplary routine for controlling engine torque/engine re-start is provided generally at 400. First, in 410, the routine determines the primary communication link status between the engine control unit and the valve control unit. As examples, the status of the primary communications link between the engine control unit and the valve control unit may be operational, degraded (shown at 412), or restored (shown at 438).

If the primary communications link between the engine control unit and the valve control unit is detected as degraded, then the routine proceed to 414, where the valve control unit uses a preloaded valve schedule and torque smoothing strategy during the transition. The degradation state of the communication link is communicated to the engine control unit via a valve control unit status message at 416. In response, at 418, the engine valve control unit uses throttle to control engine torque. The engine speed is calculated with CPS or CAM signal at 420.

The routine continues at 422 by determining if there is an engine stall. If the engine is not stalled, then the routine proceeds to 410, where the status of primary communication link between the engine control unit and the valve control unit is again determined.

If the engine is stalled, then the routine continues at 424 and 426, where the restart capability of the valve control unit is assessed. If the valve control unit has the requisite restart capability, then a status message, such as in-operation status message, is sent to the engine control unit via a valve control unit status message at 428. In 430, the CID signal is used from CID/CAM line or back up link to synchronize intake valve timing with exhaust CAM. For example, on an engine having electrically actuated intake valves and cam actuated exhaust valves, the CID signal may be used to synchronize the exhaust cam and intake valves to avoid a possible thermal event. The engine is then restarted at 432 and the routine proceeds to 410, where the status of primary communication link between the engine control unit and the valve control unit is again determined.

If the valve control unit does not have restart capability, at 426, then a power-down message, indicated at 434 may be sent to the engine control unit via a valve control unit status message. The routine may continue with the powering down of the engine control unit and the valve control unit at 436. In some embodiments, the routine may proceed to 410, where again the status of primary communication link between the engine control unit and the valve control unit is again determined.

Referring back to the determination of the status of the communication link between the engine control unit and the valve control unit at 410, if the communication link is restored, at 438, the valve control unit communicates status to the engine control unit at 440. Then, at 442, the engine control unit uses valve timing to control engine torque and the valve control unit uses the engine control unit commanded valve timing and torque smoothing strategy during the transition. The routine then continues to 410, where the status of the primary communication link between the engine control unit and the valve control unit is determined.

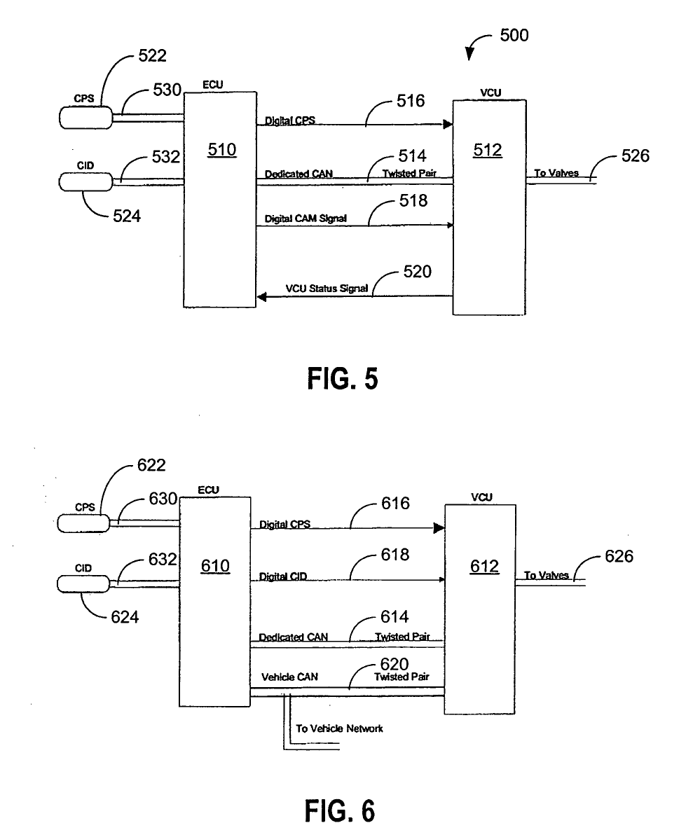

FIG. 5 provides an example valve control unit/engine control unit interface at 500. In the example embodiment, the engine control unit 510 communicates to valve control unit 512 through a transmission medium, such as a dedicated controller area network (CAN) BUS 514, as the primary communication link. The CAN BUS may be a twisted pair of wires. The dedicated CAN network may be configured to relay desired/actual valve timing to the valve control unit for operation of the valves.

A digital CPS signal 516 may be transmitted from the engine control unit 510 to the valve control unit 512 over a single line/wire.

Similarly, a digital CAM position signal 518 may be transmitted from the engine control unit 510 to the valve control unit 512 over a single line/wire. It should be appreciated that the digital CAM signal may be a single wire CID. The single wire CID may allow for resynchronization and CPS back up. A single wire transmission may be beneficial in reduce system cost and potential interference, such as EMI (electromagnetic interference).

A message system may be provided between the valve control unit and the engine control unit to ensure the valve control unit operational state. For example, valve control unit 512 may be linked to the engine control unit through a message system, such as a valve control unit status signal 520.

It is noted that the engine control unit 510 may be linked to CPS 522 and CID 524, while valve control unit 512 may be linked to valves 526. Also, the crankshaft (e.g., CPS) signal 530 to ECU 510 may be analog or digital, and the camshaft (e.g., CID) signal 532 to the ECU may be analog or digital.

In the above example, the primary communication link between the engine control unit and valve control unit provides the controls for the valve timing to deliver a desired engine torque. As described above, disruption of the primary communications link may result in loss of engine control signal to the valve control unit. However, in the embodiment shown in FIG. 5, a back up system may be provided, such as a single wire digital CPS signal and a digital CAM signal. In some embodiments, a CID pin may be provided for engine restart after dedicated CAN loss and CPO signal loss back up.

Further, in addition to the back-up system, a message system, such as the VCU status signal 520, may update the engine control unit of the status of the valve control unit. Such a message system may be operational regardless of the disruption of the primary communication link. By maintaining a status link even in the failure of the primary communication link, the engine control unit may be able to react to the operation condition of the valve control unit.

In operation, the engine control unit communicates valve timing commands to the valve control unit through the primary communication link, dedicated CAN 514. During loss or disruption of CAN communications, the engine control unit and valve control unit transition to the back up system and message system such that the valve control unit operates on a preset valve timing schedule and the valve control unit status signal confirm the valve control unit functionality.

FIG. 6 shows an alternative example valve control unit/engine control unit interface at 600. In the example embodiment, the engine control unit 610 communicates to valve control unit 612 through a dedicated transmission medium, such as a dedicated CAN BUS 614, as the primary communication link. As described above, the dedicated CAN BUS may be a twisted pair of wires. The dedicated CAN network may be configured to relay desired/actual valve timing to the valve control unit for operation of the valves.

A digital CPS signal 616 may be transmitted from the engine control unit 610 to the valve control unit 612 over a single line/wire. A digital CID signal 618 may be transmitted from the engine control unit 610 to the valve control unit 612 over a single line/wire. The single wire CID may allow for CPS back up.

As with the previous embodiment, a message system may be provided between the valve control unit and the engine control unit to ensure the valve control unit operational state. The valve control unit 612 may be linked to the engine control unit 610 through a message system, where the valve control unit messages may be transmitted from the valve control unit to the engine control unit over back-up communication BUS, where the Vehicle CAN 620 is shown as the back up communication BUS. The Vehicle CAN may be linked to the vehicle network.

As with the above example, engine control unit 610 may be linked to CPS 622 and CID 624, while valve control unit 612 may be linked to valves 626.

In the above example, the primary communication link between the engine control unit and valve control unit provides the controls for the valve timing to deliver a desired engine torque. As described above, disruption of the primary communications link may result in loss of engine control unit signals to the valve control unit. However, in the embodiment shown in FIG. 6, a back up system may be provided, where the Vehicle CAN may be used for transmission of CID and/or valve control unit status.

Thus, in some embodiments, the Vehicle CAN may be a message system, such that the valve control unit may update the engine control unit regarding the operational status of the valve control unit. Such a message system may be operational regardless of the disruption of the primary communication link. By maintaining a status link even in the failure of the primary communication link, the engine control unit may be able to react to the operation condition of the valve control unit. Further, it may be possible to retain the CID pin for CPS signal loss back up.

In operation, the engine control unit communicates valve timing commands to the valve control unit through the primary communication link, dedicated CAN 614. During loss or disruption of CAN communications, the vehicle CAN network provides base or preset valve timing requirement which allows the vehicle to function in full ETC (electronic throttle control, such as using engine torque control in response to a driver requested torque) mode. Additional functionality may be provided depending on the Vehicle CAN bandwidth.

FIG. 7 provides a chart of operation status messages which may be sent from the valve control unit to the engine control unit. As described above, such messages may be sent during a disruption or loss of primary communication between the engine control unit and the valve control unit. Additionally, in some embodiments, the message system may remain active even when the primary communication link between the engine control unit and the valve control unit is operational.

As shown in FIG. 7, the messages may include general data information, valve operation information, and/or data information. For example, general data information may include VCU enable information, VDE mode (stroke number), cycle/TDC counter information, cylinder number, engine load information, coolant temperature, etc. Valve operation information may include valve timing information, valve startup/restart information, valve open/closed information, valve mobile/rest information, ballistic (oscillatory mode to reduce power consumption in moving away from a null position) and levitation information (holding at a position other than a null position), etc. Similarly, data information may include VCU power consumption, valve state, cycle/TDC counter, etc.

The messages may be of any suitable size. In one embodiment, the following CAN loading calculation may be used:

$$Loading = \frac{N \cdot {N}_{b}}{15 \cdot {R}_{CAN}}$$

where,
N Engine speed (RPM)
N_{b} Number of bits sent every 90° CA
R_{CAN} transmission rate (bits/s)

CAN Load may be desired to be less than 30%. As such, in some embodiments, each message may require 47 bits of overhead for communication. As an example, 333 bits may be required to cover all regularly sent messages. Even at 333 bits, the CAN load is still under 30% as follows:
At N=6000 (RPM), assuming R_{CAN}=500 (kbits/s), we have at most, Loading=6000*333/15/500/1000=26.7%

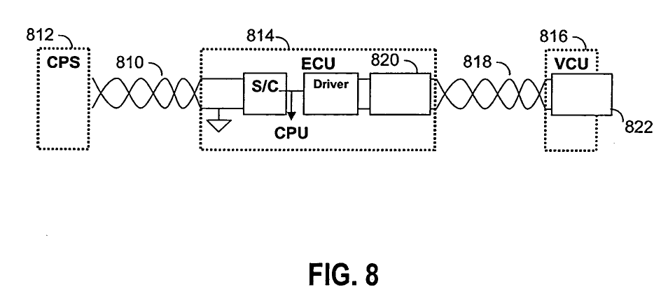

Note that in some applications, signal processing, such as filtering, may be used to enhance transmission of signals between a sensor, the ECU, and/or the VCU. For example, referring to FIG. 8, a block diagram illustrates transmission of the crankshaft position sensor signal 810 from the CPS sensor 812 to the ECU 814, and then on to the VCU 816 via transmission line 818. In this example, filtering is applied to at least one of the signal from the sensor (such as in the ECU in block 820) and the signal from the ECU to the VCU (such as in the VCU in block 822), or possibly both. One example filtering that may be used is defined by SAE J1708, however others may also be used, such as other RC filters applied to twisted pair wires. The filtering in the ECU may reduce noise on other nearby signals, while the filtering in the VCU may reduce any noise picked-up from other nearby signals in the transmission.

It will be appreciated that the configuration and routines disclosed herein are exemplary in nature, and that these specific embodiments are not to be considered in a limiting sense as numerous variations are possible. For example, the above approaches by be applied to any suitable engine type and valve control system. Further, additional back up systems and messaging systems may be provided between the engine control unit and the valve control unit. Further, more than one preset valve timing schedule may be provided as a back up valve timing system.

The subject matter of the present disclosure includes all novel and nonobvious combinations and subcombinations of the various systems and configurations, and other features, functions, and/or properties disclosed herein. For example, the engine may have separate groups of cylinders (e.g., banks of a V-type engine). In such a system, it may be an advantage to send the CAM signals from both a first and second bank of the engine from the engine control module to the VCU separately over the digital CAM signal line(s). For example, the separate CAM signals from Bank A and B may have sufficient information to allow synchronization of the engine in 90 crank angle degrees, whereas a composite signal may only support synchronization at a lower rate, e.g. every 720 degrees. The ability to synchronize the engine at higher rates, i.e. every 90 vs. 720 degrees, has been shown to be valuable during the initialization process, i.e. clod start by enabling faster synchronous fuel injection, for example, to thereby lower emissions. Therefore it may be advantageous to use two sets of signal lines to separately transmit the CAM signals from each bank from the engine control module to the VCU, if the engine has more than one bank, e.g. a V-8 engine.

As another example, the crankshaft position and/or CAM position sensor signals may first be processed by a fuel injection control module, and then transmitted to the engine control module.

Further note that the crank shaft position sensor signal may be sent to both the engine control module and the valve control unit, with the signal first routed to the engine control module and then to the second unit after buffering (i.e. with an Op-Amp, the signal is routed to the valve control unit). Also, the CAM shaft position sensor signal may be sent to both the engine control module and the valve control unit.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for controlling engine torque during disruption of a primary communication link between an engine control unit and a valve control unit in an engine, the method comprising:
determining disruption of the primary communication link between the engine control unit and the valve control unit;
operating a preset valve timing schedule upon determination of disruption of the communication link between the engine control unit and the valve control unit; and
sending a status message from the valve control unit to the engine control unit regarding the operational status of the valve control unit.

2. The method of claim 1 wherein said preset valve timing schedule is included with the valve control unit.

3. The method of claim 1 wherein operation of the preset valve timing schedule requires no communication from the engine control unit.

4. The method of claim 1 wherein said preset valve timing schedule is varied as a function of engine speed.

5. The method of claim 1 wherein the status message includes valve operation information.

6. The method of claim 1 wherein the status message includes valve control unit information, including one of valve state, valve control unit power consumption, identification of operable cylinder or valve, calculated engine speed, and information regarding recovery status.

7. The method of claim 1 further comprising executing a backup system from the engine control unit to the valve control unit.

8. The method of claim 7 wherein executing the backup system includes transmitting a digital CPS signal over a CPS communication link from the engine control unit to the valve control unit, where the CPS communication link is separate from the primary communication link.

9. The method of claim 7 wherein executing the backup system includes transmitting a digital CAM signal over a CAM communication link from the engine control unit to the valve control unit, where the CAM communication link is separate from the primary communication link.

10. The method of claim 7 wherein executing the backup system includes transmitting a CID signal over a CID communication link from the engine control unit to the valve control unit, where the CID communication link is separate from the primary communication link.

11. The method of claim 10, further comprising synchronizing valve timing based on the CID signal and restarting the engine.

12. The method of claim 1 wherein said status message may include an engine speed calculated by the valve control unit via a twisted pair that is driven by a PWM driver on the valve control unit.

13. An interface between an engine control unit and a valve control unit for controlling engine torque in an engine, the interface comprising:
a primary communication link between the engine control unit and the valve control unit;
at least one back up signal line separate from the primary communication link from the engine control unit to the valve control unit operable during disruption of the primary communication link; and
a message system separate from the primary communication link configured to enable transmission of valve control unit status information to the engine control unit during disruption of the primary communication link.

14. The interface of claim 13, wherein the back up signal line transmits one of a CID or CAM signal to the valve control unit.

15. The interface of claim 13, wherein the message system is included with the vehicle controller area network.

16. The interface of claim 12, wherein the message system includes a separate signal line from the valve control unit to the engine control unit.

17. The interface of claim 13, wherein the valve control unit initiates a preset valve timing schedule upon a determination of disruption of the primary communications link.

18. An automotive engine comprising:
an engine control unit;
a valve control unit in communication with the engine control unit via a dedicated link;
at least one backup communication link from the engine control unit to the valve control unit operable during disruption of the dedicated link; and
a message system from the valve control unit to the engine control unit to provide valve control operational status information.

19. The automotive engine of claim 18, wherein the backup communication link is configured to transmit one of a CID or a CAM signal.

20. The automotive engine of claim 18, wherein the message system includes a separate communication link between the valve control unit and the engine control unit.

21. The automotive engine of claim 18, wherein the message system is included with the vehicle controller area network.

22. The automotive engine of claim 18, wherein the engine control unit is operative in a first mode to control valve timing; and where the valve control unit is operative in a second mode to control valve timing based on a fixed valve timing schedule when the dedicated link is disrupted.

23. A method for controlling engine operation, comprising:
stopping engine operation in response to degraded communication between an engine control unit and a valve control unit, where the valve control unit controls valve operation of at least one electrically actuated cylinder valve of the engine, and
restarting the engine, even in the presence of the degraded communication, using a communication of cam or crank angle separate from said degraded communication.

24. The method of claim 23 wherein the engine further comprises at least one cam actuated engine cylinder valve.

25. The method of claim 23 wherein said communication includes communication of a first cam signal from a first bank of the engine and a second cam signal from a second bank of the engine.

26. The method of claim 23 wherein cam or crank signal information is provided to both the engine control unit and the valve control unit.
